(19) United States
(12) Patent Application Publication
(10) Pub. No.: US 2009/0042515 A1
(43) Pub. Date: Feb. 12, 2009

(54) TRANSPONDER CIRCUIT

(76) Inventors: Thomas OSTERTAG, Geretsried (DE); Rudiger Hutter, Geretsried (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/181,967

(22) Filed: Jul. 29, 2008

Related U.S. Application Data
(63) Continuation of application No. 10/520,811, filed on Jun. 27, 2006, now abandoned.

(51) Int. Cl. H04B 1/38; H04Q 5/22

(52) U.S. Cl. 455/73; 340/10.34

(57) ABSTRACT

The invention relates to a transponder circuit comprising a high-quality resonator and a demodulator. After being demodulated, the AM-modulated signal emitted by an emitting and receiving appliance has a frequency corresponding to the resonance frequency of the high-quality resonator, for exciting the high-quality resonator. Said transponder circuit also comprises a rectifier, an energy accumulator and a semiconductor circuit which are connected downstream of the resonator. The input impedance of the high-quality resonator is adapted to the loaded impedance of the semiconductor circuit in such a way that a supply voltage for the semiconductor circuit is obtained in the energy accumulator by means of the impedance transformation. Data and/or measuring values can be retrieved and/or updated in a non-contact manner by radio by means of the transponder circuit. The inventive transponder circuit can be applied to ID generators, sensor systems which are self-sufficient in energy or memories for data, for example for measuring systems.

The invention relates to a transponder circuit with a resonator with a high quality factor and a demodulator. After its demodulation, an AM-modulated signal transmitted by a transmitter/receiver device has a frequency for exciting the resonator with a high quality factor that corresponds to the resonance frequency of the resonator with a high quality factor.

Employing transponders for identification tasks is known. The known system (see Finkenzeller, “RFID-Handbuch” [RFID Handbook], 2nd edition, Hanser Verlag, Munich, 2000, ISBN 3446-21278-7) require either high field strengths of the reading device or a battery for supplying power to the necessary semi-conductor circuits. Transmittable data for SAW transponders, which are also known, are fixed during manufacture and cannot be changed.

Data and/or measurement values can be called up and/or updated in a contactless manner using the transponder circuit. The resonator with a high quality factor matches an input impedance to the load impedance of the semiconductor circuit. Potential, but not exclusive, applications of this invention are identification transponders, energy autarchic sensor systems, or memories for data, e.g. for the measurement system described in DE 0019621354.

For example, DE 19535543 A1 relates to such a radio interrogation system in which a broadband transmitter/receiver device and an identification and/or sensor arrangement acting as a transponder are provided with resonators with a high quality factor, whereby the resonators have such a high quality factor that energy is stored in them. The energy is stored until the interfering frequencies of the interrogation pulse have decayed. For this, different types of resonators are used depending on frequency range and the variables to be detected. In addition, appropriate transformers are provided in order to convert the signal from the antenna of the transponder to an input that is suitable for the resonators being used.

DE 19844142 C2 discloses a programmable HF block for mobile radio applications whereby for adjusting a mechanically tunable tuning network, individually adjustable passive components such as for instance resonators are provided. The tuning network is adjusted in that one electric micromotor that can be controlled by a programmable control unit is allocated to each adjustable passive component, whereby the characteristic values of the resonators can be adjusted mechanically by displacing the grounding point. During the actual adjusting period the resonators consume electrical energy.

U.S. Pat. No. 6219532 B1 relates to impedance-matching circuits of a tuning network between antenna and transmitter/receiver device of a mobile radio device. A first and a second impedance-matching circuit have different impedances, whereby each of the circuits works such that an impedance from the antenna side corresponds to an impedance from the transmitter/receiver circuit side.

The object of the invention is to provide the energy supply for a semiconductor circuit with which a transponder can be realized and in which the cited problems do not occur.

The object of the invention is achieved in that the transponder circuit additionally has a rectifier, an energy store, and a semiconductor circuit that are downstream of the resonator and the input impedance of the resonator with a high quality factor is matched to the load impedance of the semiconductor circuit such that a supply voltage is obtained for the semiconductor circuit in the energy store using impedance transformation.

Thus, a fundamental concept of the invention is to enable appropriate matching between the input impedance of the resonator with a high quality factor and the load impedance of the semiconductor circuit, that is, the impedances of different special components of the transponder circuit are matched.

In one preferred embodiment, a broadband signal is used to excite the resonator. A two-tone signal can also be used to excite the resonator.

In another preferred embodiment, the frequency of the exciting signal is matched to the resonator frequency of the resonator (tracking).

As is known, the reciprocal of the damping d of an oscillating circuit is called the quality factor Q (Q=1/d). An oscillating circuit with a high quality factor thus has low damping.

Preferably a quartz is used for the resonator with a high quality factor. It is also useful for a piezoelectric resonator to be provided as resonator with a high quality factor. A piezoelectric resonator made of langasite, gallium orthophosphate, or lithium niobate can be used. The specific design of the required resonator with a high quality factor is not critical as long as the requirement for a high quality factor is satisfied. Additional designs for resonators with a high quality factor are:
Quartz,
IC oscillating circuits,
Ceramic resonators,
Cable resonators,
Dielectric resonators,
Acoustic resonators,
Antennas,
Tuning-fork oscillators,
Mechanical oscillators,
Ferrimagnetic resonators, or
Resonators that work with magnetostatic waves.

In another preferred embodiment, the stored data are used for calibrating sensors.

The invention is explained in greater detail in the following using the drawing, which is a schematic illustration of a radio interrogation system with a transmitter/receiver device and a battery-less transponder circuit as the element to be interrogated.

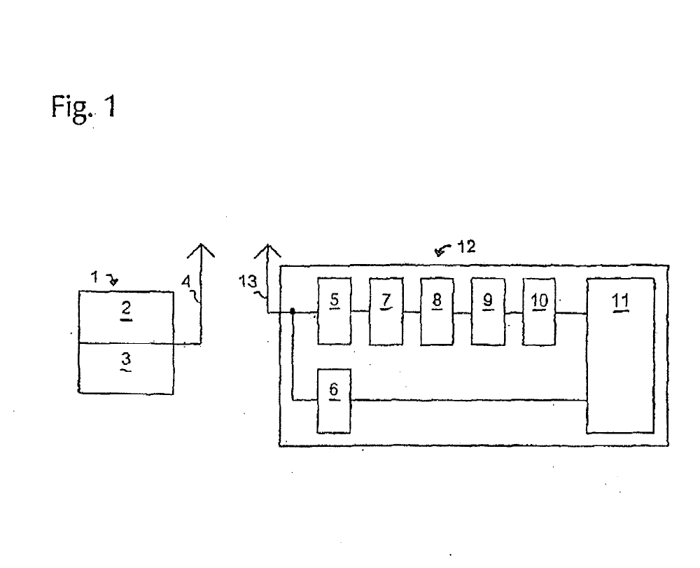

FIG. 1 illustrates a reading device (1) with integrated transmitter/receiver device (2) and (3) and a transponder (12). The radio connection between reading device (1) and transponder (12) occurs via the antenna of the reading device (4) and the antenna of the transponder (13). Once the antenna of the transponder (5) is matched, the signal is forwarded to the demodulator (7) and then to the resonator with a high quality factor (8) for exciting oscillation. Downstream of the resonator (8) are a rectifier (9), an energy store (10), and a semiconductor circuit (11). Then the signal is returned to the antenna of the transponder (13) via a backscatter modulator (6).

The transponder information is read out in two steps. First an AM-modulated carrier frequency is transmitted by the transmitter (2). After demodulation (7), the modulation signal excites the resonator with a high quality factor (8). The AM modulation frequency corresponds to the resonance frequency of the resonator. Due to the high quality factor, impedance transformation takes place, whereupon a relatively high supply voltage, required for the semiconductor circuit (11), is obtained in the energy store (10). At this point the semiconductor circuit is idle, a very small amount of current being consumed, which Is the same as a very high impedance.

Once the modulation is turned off, but the carrier is still present, the semiconductor circuit (11) can send the useful data back to the receiver (3) via the known backscatter modulation circuit (6).

The high quality factor of the resonator (8) requires excitation at the exact resonance frequency. However, at first this resonance frequency is not precisely known due to production tolerances or detuning by external influences (e.g. temperature or aging). As described in DE 19535543, the resonator can be excited with broadband, whereby however only a small portion of the modulation energy is available for this excitation. Alternatively, it is possible to derive from the backscatter signal a tracking signal with which the modulation frequency can be matched to the resonator and when needed tracked (see DE 0019621354).

Only the frequency of the AM modulation is relevant for the function of this invention. Thus the reading device and the antenna of the transponder can be designed as broadband, so that if there is interference it is possible to switch to a frequency with no interference.

Such interference can for instance be caused by foreign devices working on the same frequency or by radio field conditions (multipath reception). Another advantage is the option of matching the transponder and the reading device without limiting the fundamental function to the carrier frequency best suited for the purpose. In this way an antenna can be used that has been optimized for a variable or range, or the regulatory conditions at the employment site can be taken into consideration.

1. A transponder circuit with a resonator with a high quality factor and a demodulator, whereby an AM-modulated signal that is transmitted by a transmitter/receiver device and that after its demodulation has a frequency for exciting the resonator with a high quality factor that corresponds to the resonance frequency of the resonator with a high quality factor, wherein
said transponder circuit additionally has a rectifier, an energy store, and a semiconductor circuit that are downstream of said resonator and the input impedance of said resonator with a high quality factor is matched to the load impedance of said semiconductor circuit such that a supply voltage is obtained for said semiconductor circuit in said energy store by impedance transformation.

2. The transponder circuit in accordance with claim 1, further comprising
a broadband signal is used for exciting configured to excite said resonator.

3. The transponder circuit in accordance with claim 1, further comprising
a two-tone signal configured to excite said resonator.

4. The transponder circuit in accordance with claim 1, wherein
the frequency of the excitation signal is matched to the resonance frequency of said resonator (tracking).

5. The transponder circuit in accordance with claim 1 wherein
a quartz is used as resonator with a high quality factor.

6. The transponder circuit in accordance with claim 1 wherein
a piezoelectric resonator is used as resonator with a high quality factor.

7. The transponder circuit in accordance with claim 6, wherein
a piezoelectric resonator made of langasite is used as resonator with a high quality factor.

8. The tansponder circuit in accordance with claim 6, wherein
a piezoelectric resonator made of gallium orthophosphate is used as resonator with a high quality factor.

9. The transponder circuit in accordance with claim 6, wherein
a piezoelectric resonator made of lithium niobate is used as resonator with a high quality factor.

10. The transponder circuit in accordance with claim 1 wherein
an LC oscillating circuit is used as resonator with a high quality factor.

11. The transponder circuit in accordance with claim 1 wherein
a ceramic resonator is used as resonator with a high quality factor.

12. The transponder circuit in accordance claim 1 wherein
a cable resonator is used as resonator with a high quality factor.

13. The transponder circuit in accordance with claim 1 wherein a dielectric resonator is used as resonator with a high quality factor.

14. The transponder circuit in accordance with claim 1 wherein
acoustic resonators are used as resonators with a high quality factor.

15. The transponder circuit in accordance with claim 1 wherein
an antenna is used as resonator with a high quality factor.

16. The transponder circuit in accordance with claim 1 wherein
tuning-fork oscillators are used as resonators with a high quality factor.

17. The transponder circuit in accordance with claim 1 wherein
mechanical oscillators are used as resonators with a high quality factor.

18. The transponder circuit in accordance with claim 1 wherein
ferrimagnetic resonators are used as resonators with a high quality factor.

19. The transponder circuit in accordance with claim 1 wherein
resonators working with magnetostatic waves are used as resonators with a high quality factor.

20. The transponder circuit in accordance with claim 1 wherein
the stored data are used for calibrating sensors.
